(19) United States
(12) Patent Application Publication
(10) Pub. No.: US 2026/0061437 A1
(43) Pub. Date: Mar. 5, 2026

(54) WATER FLOW SHAPER

(71) Applicant: Xiamen Water Nymph Sanitary Technology Co.,Ltd., Xiamen (CN)

(72) Inventors: Huaqiang ZHOU, Xiamen (CN); Zhiwei ZHUO, Xiamen (CN); Fang ZHENG, Xiamen (CN)

(73) Assignee: Xiamen Water Nymph Sanitary Technology Co.,Ltd., Xiamen (CN)

(21) Appl. No.: 19/385,026

(22) Filed: Nov. 10, 2025

Related U.S. Application Data
(63) Continuation of application No. PCT/CN2023/135341, filed on Nov. 30, 2023.

(30) Foreign Application Priority Data
May 12, 2023 (CN) 202310537988.4

(51) Int. Cl. B05B 1/34

(52) U.S. Cl. CPC B05B 1/34

(57) ABSTRACT

The disclosure discloses a water flow shaper including a water outlet body and a water outlet panel rotatably connected to the water outlet body, where the water outlet body is provided with a water outlet chamber, the water outlet chamber is provided with a water outlet, and an inner diameter of the water outlet is smaller than a maximum diameter of the water outlet panel; and the water outlet is provided with a clearance opening, such that the water outlet panel can be fitted into or detached from the water outlet through the clearance opening. In the disclosure, the water outlet panel can be quickly assembled and disassembled, and the difficulty of cleaning a water outlet screen is reduced.

### CROSS-REFERENCE TO RELATED APPLICATIONS

This application is a continuation application of International Application No. PCT/CN2023/135341, filed on Nov. 30, 2023, which claims priority to Chinese Application No. 202310537988.4, filed on May 12, 2023. The disclosures of the above-mentioned applications are hereby incorporated by reference in their entireties.

### TECHNICAL FIELD

The disclosure relates to the field of sanitary ware, in particular to a water flow shaper.

### BACKGROUND

Existing multi-functional sanitary products, such as aerators and shower heads, typically adopt rotation adjustment or press adjustment to change the communication relationship of water channels, thereby generating water sprays in different forms for altering water flow states.

Water outlet ends of such products are usually provided with a water outlet screen to shape the water flow, so as to generate different water sprays. However, after long-term use, the water outlet screen is prone to scale adhesion or clogging by impurities, resulting in unsmooth water flow of the sanitary product or deformation of water sprays. To solve these technical problems, it is often necessary to disassemble the sanitary product and clean the water outlet screen with a descaling agent and other cleaning tools. Nevertheless, the existing multi-functional sanitary products generally have a complex structure, and in order to ensure the integrity of the product appearance, they often come with an integrated external housing, which increases the difficulty of disassembling or installing the water outlet screen, and further makes it challenging for a user to clean the water outlet screen in daily use.

### SUMMARY

The disclosure relates to a water flow shaper, including a water outlet body and a water outlet panel rotatably connected to the water outlet body, where

the water outlet body is provided with a water outlet chamber, the water outlet chamber is provided with a water outlet, and an inner diameter of the water outlet is smaller than a maximum diameter of the water outlet panel; and

the water outlet is provided with a clearance opening, and a minimum distance from the clearance opening to an axis center of the water outlet is greater than a radius of the water outlet, such that the water outlet panel can be fitted into or detached from the water outlet through the clearance opening.

### BRIEF DESCRIPTION OF THE DRAWINGS

FIG. 1 is an exploded view of a water flow shaper according to some embodiments of the disclosure.

FIG. 2 is a first schematic structural diagram of a water flow shaper according to some embodiments of the disclosure.

FIG. 3 is a second schematic structural diagram of a water flow shaper according to some embodiments of the disclosure.

FIG. 4 is a sectional view of a water flow shaper according to some embodiments of the disclosure.

FIG. 5 is a bottom view of FIG. 2.

FIG. 6 is a first schematic structural diagram of a water flow shaper according to some embodiments of the disclosure.

FIG. 7 is a second schematic structural diagram of a water flow shaper according to some embodiments of the disclosure.

FIG. 8 is a third schematic structural diagram of a water flow shaper according to some embodiments of the disclosure.

FIG. 9 is a first sectional view of a water flow shaper according to some embodiments of the disclosure.

FIG. 10 is a second sectional view of a water flow shaper according to some embodiments of the disclosure.

### DETAILED DESCRIPTION OF THE EMBODIMENTS

To describe the technical contents, objectives, and effects of the disclosure in detail, the following description is given in conjunction with the embodiments and accompanying drawings.

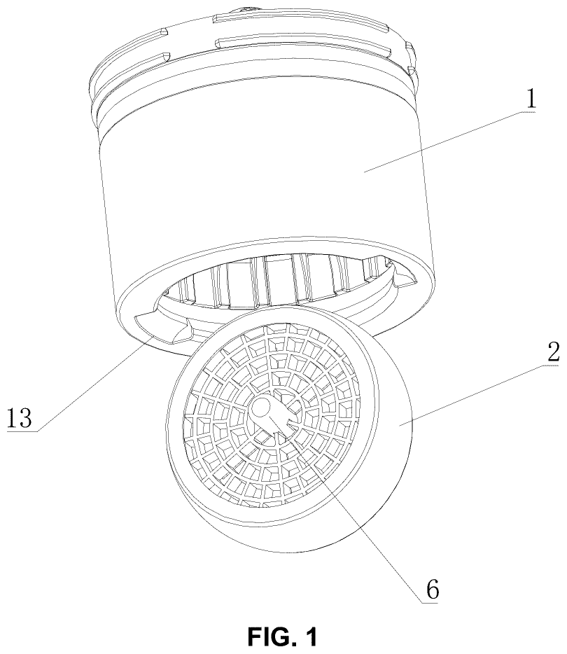

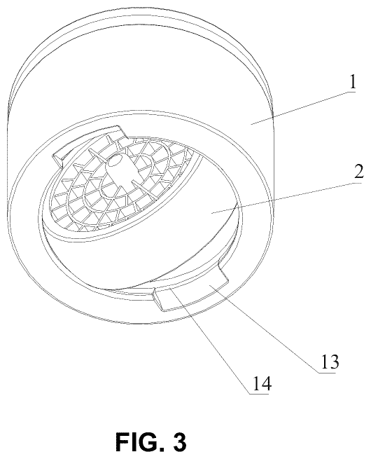

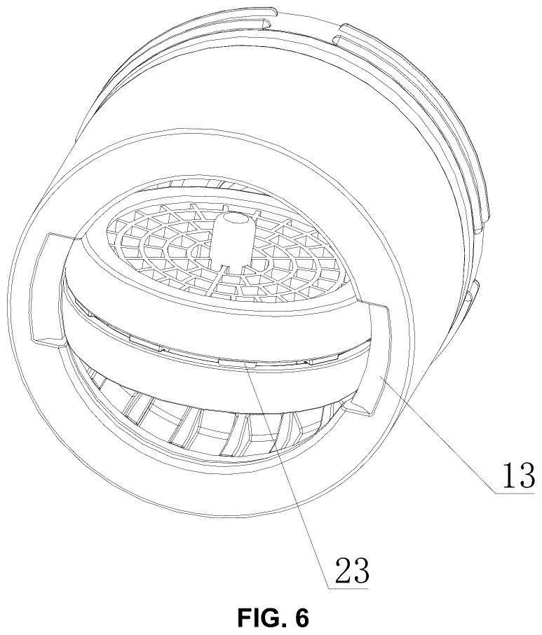

Referring to FIGS. 1 to 10, a water flow shaper includes a water outlet body 1 and a water outlet panel 2 rotatably connected to the water outlet body 1. “Rotatably connected” means that the water outlet panel 2 can be flipped over relative to the water outlet body 1 within the water outlet body 1. The water outlet panel 2 is configured to filter impurities and regulate water flow. The water outlet body 1 is provided with a water outlet chamber 11, and the water outlet chamber 11 is provided with a water outlet 12. The water outlet 12 is an opening formed at a position where the water outlet panel 2 is located. An inner diameter of the water outlet 12 is smaller than a maximum diameter of the water outlet panel 2. The water outlet 12 is provided with a clearance opening 13 which is a clearance space formed by a depression in an inner wall of the water outlet chamber 11, such that the water outlet panel 2 can be fitted into or detached from the water outlet 12 through the clearance opening 13. Under the above conditions, the materials of the water outlet body 1 and the water outlet panel 2 are not limited to elastic or rigid materials, such that the water outlet panel 2 can be applied to more situations.

It can be understood that the clearance opening 13 is arranged in the disclosure to provide a clearance space for the water outlet panel 2 to be fitted into or detached from the water outlet 12. In this case, when the water outlet body 1 has no or an extremely small deformation space, the water outlet panel 2 can be quickly fitted or pulled out, thereby reducing the difficulty of assembling and disassembling the water outlet panel 2. When the inner diameter of the water outlet 12 is smaller than the maximum diameter of the water outlet panel 2, the portion of the water outlet panel 2 with the maximum diameter is always located on a side of the water outlet chamber 11 away from the water outlet 12, such that the water outlet panel 2 can remain stable under water flow impact without detaching from the water outlet chamber 11, and further the water outlet panel 2 can be quickly assembled and disassembled while maintaining a relatively stable positional relationship with the water outlet body 1 during normal use. Compared with the prior art, the disclosure does not require overall disassembly and assembly, and users only need to pull out or embed the water outlet panel 2 from or into the water outlet body 1. The disassembly and assembly process can even be completed manually without other tools, greatly reducing the difficulty of cleaning the water outlet panel 2, further maintaining a good water outlet effect of the water outlet device, and prolonging the effective service life of the water outlet device.

In some embodiments, the clearance opening 13 is gradually recessed in a radial direction of the water outlet 12 along a direction opposite to a water outlet direction. In a sectional view of the clearance opening 13 in an axial direction of the water outlet body 1, the clearance opening is arc-like and is configured to guide the embedding of the water outlet panel 2.

In some embodiments, a minimum distance from the clearance opening 13 to an axis center of the water outlet 12 is greater than a radius of the water outlet 12, such that a clearance space sufficient for the water outlet panel 2 to be pulled out or fitted is formed at the clearance opening 13.

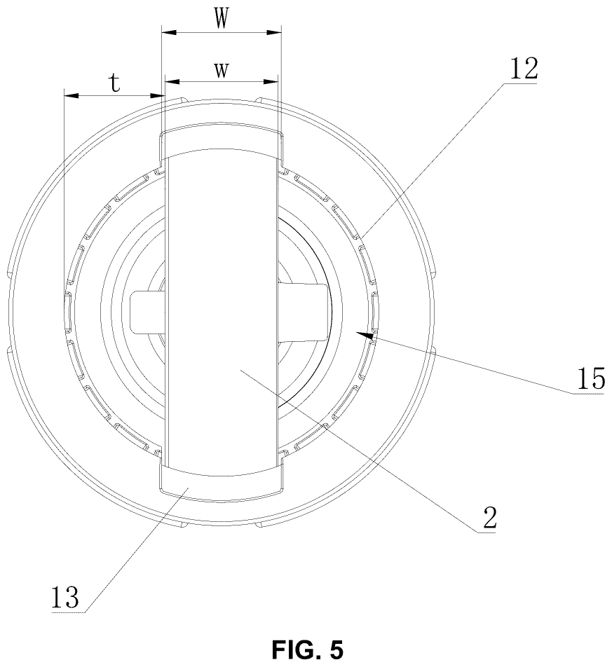

In some embodiments, referring to FIG. 5, in a circumferential direction of the water outlet 12, a length of the clearance opening 13 is not less than an axial thickness of the water outlet panel 2, so as to provide a sufficient clearance space for the water outlet panel 2 to be pulled out or fitted and ensure smooth pulling out or embedding processes of the water outlet panel 2. Optionally, a difference between the length of the clearance opening 13 and the axial thickness of the water outlet panel 2 is in a range from 0.2 mm to 1 mm, and preferably, the thickness difference is 0.3, 0.4, 0.5, 0.6, 0.7, 0.8, or 0.9. If the length of the clearance opening 13 is large, the difficulty of aligning the water outlet panel 2 with the clearance opening 13 will be reduced, and the water outlet panel 2 can be pulled out or fitted without rotating the water outlet panel 2 to a position completely facing the clearance opening 13; on the contrary, if the length of the clearance opening 13 is small, the alignment accuracy requirement between the water outlet panel 2 and the clearance opening 13 will be higher, and the binding force of a neck 14 on the water outlet panel 2 will be larger, causing that the water outlet panel 2 is not easily pulled out or fitted.

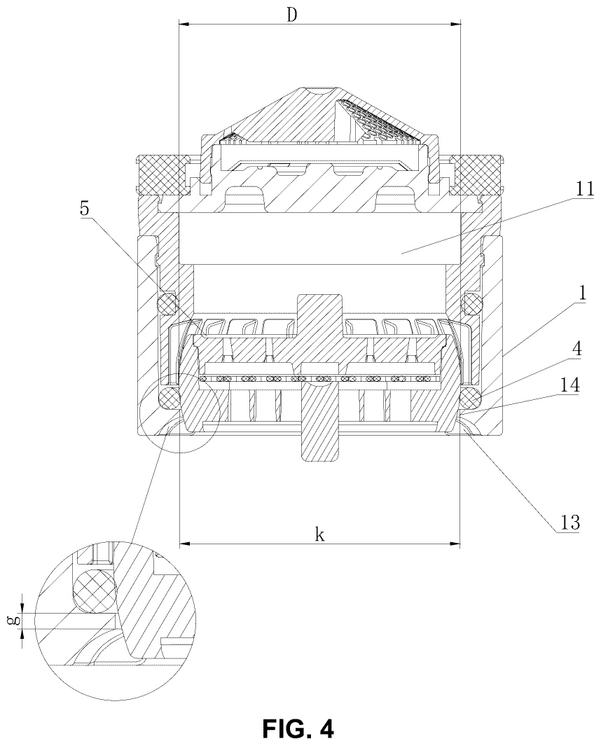

In some embodiments, referring to FIG. 4, the water outlet chamber 11 is provided with a neck 14 at a position close to the clearance opening 13, and when the water outlet panel 2 is fitted into or detached from the water outlet 12 through the clearance opening 13, the water outlet panel 2 is in transition fit with the neck 14. The transition fit between the neck 14 and the water outlet panel 2 includes three cases: first, the maximum diameter of the water outlet panel 2 is larger than a diameter of the neck 14; second, the maximum diameter of the water outlet panel 2 is smaller than the diameter of the neck 14; and third, the diameter of the water outlet panel 2 is equal to the diameter of the neck 14. When the diameter of the water outlet panel 2 is smaller than or equal to the diameter of the neck 14, the difference between the diameter of the water outlet panel 2 and the diameter of the neck 14 is in a range from 0 mm to 0.5 mm, and further, the difference is in a range from 0 mm to 0.4 mm. In this case, when the water outlet panel 2 is pulled out from or fitted into the water outlet chamber 11, the water outlet chamber 11 will not be deformed at the neck 14, and the water outlet panel 2 can be smoothly pulled out at the position facing the clearance opening 13. When the diameter of the water outlet panel 2 is larger than the diameter of the neck 14, the difference between the diameter of the water outlet panel 2 and the diameter of the neck 14 should be less than or equal to 0.1 mm. In this case, when the water outlet panel 2 is pulled out from or fitted into the water outlet chamber 11, the water outlet chamber 11 will be slightly deformed at the neck 14. Since the difference between the diameter of the water outlet panel 2 and the diameter of the neck 14 is less than or equal to 0.1 mm, the requirement for a deformation space is low. At this time, regardless of whether the water outlet panel 2 and the water outlet body 1 are made of rigid or elastic materials, the water outlet panel 2 can be pulled out from or fitted into the water outlet body 1, where most preferably, the diameter of the water outlet panel 2 is smaller than or equal to the diameter of the neck 14.

In some embodiments, in the axial direction of the water outlet body 1, a thickness of the neck 14 is in a range from 0.2 mm to 1.2 mm. Further, the thickness of the neck 14 is in a range from 0.4 mm to 0.8 mm. The neck 14 within this thickness range has good deformation performance, and the thinner the neck 14, the stronger its deformation performance. The thickness of the neck 14 can be 0.5 mm, 0.55 mm, 0.6 mm, 0.65 mm, 0.7 mm, or 0.75 mm.

In some embodiments, the difference between the diameter of the neck 14 and the maximum diameter of the water outlet panel 2 is in a range from 0.1 mm to 1 mm. In some embodiments, the difference is in a range from 0.2 mm to 0.8 mm, and preferably, the difference can be 0.25 mm, 0.3 mm, 0.4 mm, 0.5 mm, 0.6 mm, 0.7 mm, or 0.75 mm. Specifically, in some embodiments, the maximum diameter of the water outlet panel 2 is in a range from 12 mm to 30 mm.

In some embodiments, one clearance opening 13 is provided, or referring to FIGS. 1 to 5, at least two clearance openings 13 are provided. When at least two clearance openings 13 are provided, every two clearance openings 13 are symmetrically arranged in the radial direction of the water outlet 12, such that the water outlet panel 2 can be smoothly pulled out or fitted when radially facing any two symmetrically arranged clearance openings 13 as shown in FIGS. 1 to 3. When only one clearance opening 13 is provided, the requirement for the size of the neck 14 will be higher, and there should be a position between the position where the clearance opening 13 is provided and an inner wall of the water outlet chamber 11 for the water outlet panel 2 to be pulled out or fitted; while when at least two clearance openings 13 are provided, two clearance openings 13 can be preferably arranged as a pair, and with each pair symmetrically arranged in the radial direction of the water outlet 12. In this case, the requirement for the diameter size of the neck 14 is reduced, and the difficulty of pulling out or embedding the water outlet panel 2 is the lowest. The number of clearance openings 13 can be determined according to the thickness of the water outlet 12 and the water outlet panel 2.

In some embodiments, a ratio of the axial thickness of the water outlet panel 2 to the diameter of the water outlet 12 is in a range from 0.1 to 0.7. Optionally, the ratio range is from 0.167 to 0.5, and the ratio can be 0.2, 0.25, 0.26, 0.27, 0.28, 0.29, 0.3, 0.31, 0.32, 0.33, 0.34, 0.35, 0.36, 0.37, 0.4, or 0.45. If the thickness of the water outlet panel 2 is too large, when an axis of the water outlet panel 2 is perpendicular to an axis of the water outlet 12, a spacing between a water-passing surface of the water outlet panel 2 and a side wall of the water outlet 12 is too small to allow fingers of the user to be directly inserted into a gap 15 formed between the water outlet panel 2 and the water outlet 12 for the operation of pulling out the water outlet panel 2. In this case, the difficulty of separating the water outlet panel 2 from the water outlet body 1 is increased, and disassembly can only be achieved with the help of tools such as needle-nose pliers. If the thickness of the water outlet panel 2 is too small, a contact area between the water outlet panel 2 and a sealing ring will be too small, causing that the stability of the water outlet panel 2 after water flow impact is poor, and the coaxial arrangement between the water outlet panel 2 and the water outlet body 1 cannot be maintained. Therefore, the axial thickness of the water outlet panel 2 and the diameter of the water outlet 12 are limited within this value range, such that the water outlet panel 2 can be easily pulled out and can remain relatively stable relative to the water outlet body 1 under water flow impact.

In some embodiments, referring to FIGS. 4, 9, and 10, the water outlet chamber 11 is provided with a supporting portion 4 that presses against the water outlet panel 2. After the water outlet panel 2 is fitted into the water outlet 12, the contact between the water outlet panel 2 and the water outlet body 1 mainly depends on the supporting portion 4. On one hand, the supporting portion 4 is provided to ensure the sealing between the water outlet panel 2 and the inner wall of the water outlet chamber 11; on the other hand, it is used to provide radial support and serve as a rotation fulcrum for the water outlet panel 2, thereby ensuring that the water outlet panel 2 remains stable when the water outlet panel 2 is fitted into the water outlet chamber 11. When the water outlet panel 2 is subjected to water pressure towards the water outlet direction, it will contact the side wall at the water outlet 12, and a circumferential side wall at the water outlet 12 with a diameter smaller than the diameter of the water outlet panel 2 will exert a counteracting force on the water outlet panel 2, helping maintaining the connection position between the water outlet panel 2 and the supporting portion 4.

In some embodiments, the supporting portion 4 is integrally formed with the water outlet chamber 11, or the supporting portion 4 is a sealing ring arranged separately from the water outlet chamber 11. When the supporting portion 4 is integrally formed with the water outlet chamber 11, the supporting portion 4 maintains a relatively static positional relationship with the water outlet chamber 11 as a part of the water outlet chamber 11, and there are great limitations in selecting the elasticity and size of the supporting portion 4; while when the supporting portion 4 is a sealing ring arranged separately from the water outlet chamber 11, the sealing between the supporting portion 4 and the water outlet panel 2 is improved, and the size and elasticity of the supporting portion 4 can be flexibly selected, such that the water outlet panel 2 is in an optimal position and has good stability.

In some embodiments, an inner diameter of the supporting portion 4 is smaller than the maximum diameter of the water outlet panel 2, and when the water outlet panel 2 is coaxially arranged with the water outlet body 1 and completely covers the water outlet 12, the portion, having the maximum diameter, of the water outlet panel 2, is located on a side of the supporting portion 4 away from the water outlet 12. The above conditions are mainly used to limit the water outlet panel 2 in the water outlet chamber 11 after the water outlet panel 2 is fitted into the water outlet chamber 11, such that the water outlet panel 2 can maintain a relatively stable positional relationship even when subjected to water flow impact.

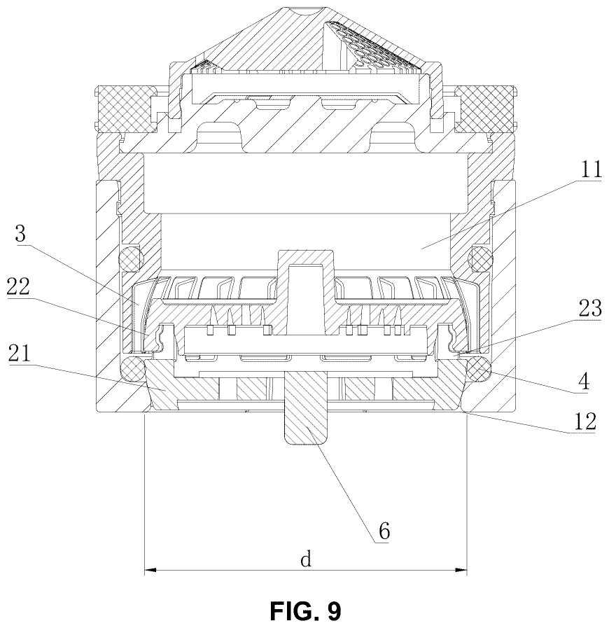

In some embodiments, referring to FIG. 9, the water outlet panel 2 is provided with a first water-passing component 21 and a second water-passing component 22, the circumferential side wall of the water outlet panel 2 is provided with a water inlet 23 in communication with both the first water-passing component 21 and the second water-passing component 22, and when the water outlet panel 2 is coaxially arranged with the water outlet body 1, the water inlet 23 is located on the side of the supporting portion 4 away from the water outlet 12. When the water outlet panel 2 is coaxially arranged with the water outlet body 1, taking the first water-passing component 21 being a water inlet surface as an example, one part of the water flow first passes through water-passing holes of the first water-passing component 21 and then enters an interior of the water outlet panel 2, and at the same time, the other part of the water flow flows into the interior of the water outlet panel 2 from the water inlet 23. The two parts of the water flow converge inside the water outlet panel 2 and then flow out through the second water-passing component 22. Since the water outlet panel 2 is rotatably connected to the water outlet body 1, both the first water-passing component 21 and the second water-passing component 22 can be used as the water inlet surface. Regardless of which component is used as the water inlet surface, one part of the water flow will enter the water outlet panel 2 from the water inlet 23 and converge with the other part of the water flow before flowing out. Therefore, the water inlet 23 is mainly configured to increase the flow rate of the water flow ultimately output from the water-passing component serving as the water outlet surface.

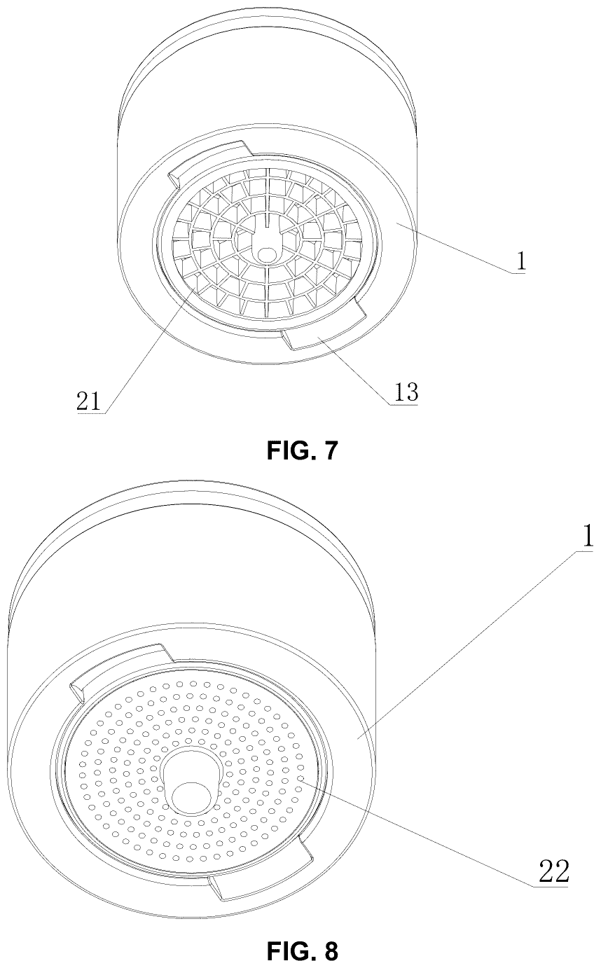

It can be understood that the first water-passing component 21 and the second water-passing component 22 are two different parts, and can be provided with completely different water outlet structures or water outlet screens. In this case, when the first water-passing component 21 or the second water-passing component 22 is used as the water outlet surface, different water sprays will be formed. Since different water outlet structures/water outlet screens have different water passing areas, when one of the components is used as the water inlet surface, the input flow rates obtained by the other water-passing component used as the water outlet surface will be different. For example, as shown in FIGS. 7 and 8, the first water-passing component 21 has a grid-shaped water outlet screen, while the water outlet structure of the second water-passing component 22 is composed of densely arranged small water-passing holes. The water passing area of the first water-passing component 21 is obviously much larger than that of the second water-passing component 22. Therefore, when the first water-passing component 21 is used as the water inlet surface, the water flow entering the water outlet panel 2 from the first water-passing component 21 has a relatively high flow rate, and when the second water-passing component 22 is used as the water inlet surface, the water flow entering the water outlet panel 2 from the second water-passing component 22 has a relatively low flow rate. Therefore, when the second water-passing component 22 is used as the water inlet surface and the first water-passing component 21 is used as the water outlet surface (i.e., the form shown in FIG. 7), the first water-passing component 21 cannot obtain a sufficient input flow rate, resulting in difficulty of forming the ultimately output water sprays (insufficient flow rate) and failing to meet the requirements of the application scenario of the water sprays. In other possible designs, a water-passing component may be provided with no more than 10 water outlet holes to output single or multiple streams with high water pressure. When such water-passing component is used as the water inlet surface, it is easy to predict that the input flow rate obtained by the other water-passing component used as the water outlet surface will be extremely low. In the above cases, the arrangement of the water inlet 23 becomes essential, and the water inlet 23 can supplement the flow rate and support the large flow rate output requirement of the water-passing component which is used as the water outlet surface.

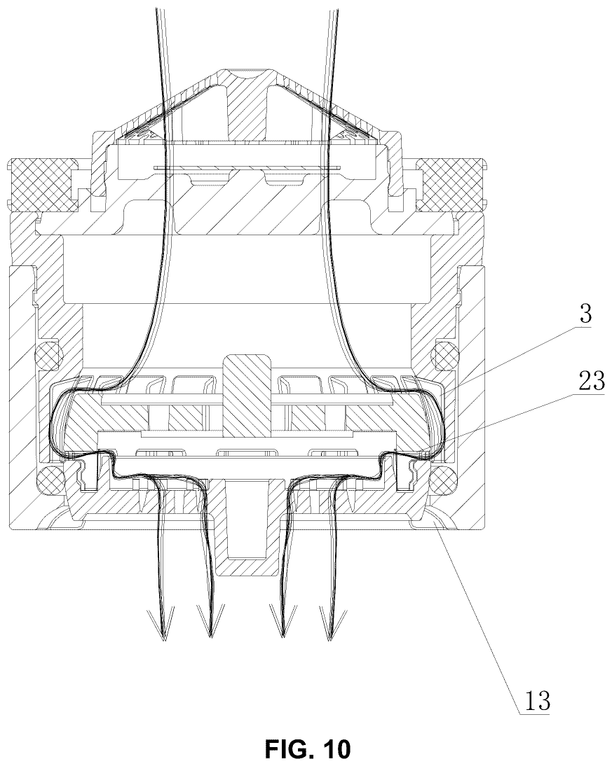

In some embodiments, referring to FIGS. 9 and 10, a water inlet channel 3 in communication with the water inlet 23 is formed between the water outlet panel 2 and the inner wall of the water outlet chamber 11 to split the water flow, thereby ensuring that part of the water flow flows into the water outlet panel 2 from the water inlet 23, while reducing the water pressure borne by the water inlet surface of the water inlet panel.

In some embodiments, the circumferential side wall of the water outlet panel 2 and the inner wall of the water outlet chamber 11 are configured as spherical surfaces or polygonal prismatic surfaces. The spherical surface includes a complete spherical surface and an incomplete spherical surface. When the circumferential side wall of the water outlet panel 2 is a complete spherical surface, in an axial sectional view of the water outlet panel 2, the circumferential side wall of the water outlet panel 2 is an arc, and the distances from each point on the arc to a three-dimensional center point of the water outlet panel 2 are equal. The incomplete spherical surface means that in the axial sectional view of the water outlet panel 2, the contour of the circumferential side wall of the water outlet panel 2 is an arc or a combination of an arc and a straight line, and the radii from each point on the arc to the three-dimensional center point of the water outlet panel 2 are not all equal. The polygonal prismatic surface means that in the axial sectional view of the water outlet panel 2, the contour of the circumferential side wall of the water outlet panel 2 is a combination of a plurality of straight lines. Correspondingly, the water outlet chamber 11 is one of a complete spherical surface, an incomplete spherical surface, or a polygonal prismatic surface, most preferably a complete spherical surface. To enable the water outlet panel 2 to rotate smoothly in the water outlet chamber 11, the circumferential side wall of the water outlet panel 2 is completely spherical, and correspondingly, the water outlet chamber 11 is also completely spherical. However, the difference lies in that there is a difference in size between the water outlet panel 2 and the inner wall of the water outlet chamber 11. Specifically, in order that the water outlet panel 2 can withstand the water flow impact and always keep pressing against the supporting portion 4 when the water outlet panel 2 is fitted into the water outlet chamber 11, in some embodiments, when the axis of the water outlet panel 2 is perpendicular to the axis of the water outlet 12, the axis of the water outlet panel 2 is located on the side of the supporting portion 4 away from the water outlet 12, such that the portion of the water outlet panel 2 with the maximum diameter is always located on the side of the water outlet chamber 11 away from the water outlet 12.

In some embodiments, in the axial direction of the water outlet panel 2, at least one side of the water outlet panel 2 is provided with a friction enhancement portion 5. Optionally, one or both sides of the water outlet panel 2 in the axial direction are provided with the friction enhancement portions 5. Specifically, the friction enhancement portions 5 can be convex lips arranged around the periphery of the surface of the water outlet panel 2, or protrusions arranged at intervals around the periphery of the surface of the water outlet panel 2, or a water outlet screen with a relatively large friction can be arranged on the surface of the water outlet panel 2.

In some embodiments, referring to FIGS. 1-5, a water flow shaper includes a water outlet body 1 and a water outlet panel 2 rotatably connected to the water outlet body 1, where the water outlet body 1 is provided with a water outlet chamber 11, the water outlet chamber 11 is provided with a water outlet 12, and an inner diameter of the water outlet 12 is smaller than a maximum diameter of the water outlet panel 2; and the water outlet 12 is provided with two symmetrically arranged clearance openings 13, such that the water outlet panel 2 can be fitted into or detached from the water outlet 12 through the clearance openings 13.

In some embodiments, referring to FIG. 4, the clearance opening 13 is gradually recessed in a radial direction of the water outlet 12 along a direction opposite to a water outlet direction.

In some embodiments, referring to FIG. 5, in a circumferential direction of the water outlet 12, a length W of the clearance opening 13 is greater than an axial thickness w of the water outlet panel 2, and the difference is 0.4 mm. The axial thickness w of the water outlet panel 2 refers to the distance between an end surface of a first water-passing component 21 and an end surface of a second water-passing component 22.

In some embodiments, the water outlet chamber 11 is provided with a neck 14 at a position close to the clearance opening 13. When the water outlet panel 2 is fitted into or detached from the water outlet 12 through the clearance opening 13, the water outlet panel 2 is in transition fit with the neck 14.

In some embodiments, in an axial direction of the water outlet body 1, a thickness g of the neck 14 is 0.55 mm, 0.6 mm, or 0.65 mm.

In some embodiments, a diameter k of the neck 14 is larger than the maximum diameter D of the water outlet panel 2, and the difference between the diameter k of the neck 14 and the maximum diameter D of the water outlet panel 2 is 0.4 mm. In other equivalent embodiments, the diameter k of the neck 14 can also be equal to or smaller than the maximum diameter D of the water outlet panel 2. When the diameter k of the neck 14 is smaller than the maximum diameter D of the water outlet panel 2, the difference between the two is smaller than 0.1 mm. The maximum diameter D of the water outlet panel 2 is in a range from 12 mm to 30 mm.

In some embodiments, a ratio of the axial thickness w of the water outlet panel 2 to a diameter d of the water outlet 12 is 0.344. When an axis of the water outlet panel 2 is perpendicular to an axis of the water outlet 12, a maximum distance t between the water outlet panel 2 and the water outlet 12 is in a range from 4 mm to 15 mm. The maximum distance t between the water outlet panel 2 and the water outlet 12 refers to the maximum distance of a gap 15 in the radial direction of the water outlet 12 in an axial projection area of the water outlet 12 under the above state as referring to FIG. 5, where the gap 15 is formed between the water outlet panel 2 and an inner wall of the water outlet 12.

In some embodiments, referring to FIGS. 4 and 9, a supporting portion 4 that presses against the water outlet panel 2 is arranged in the water outlet chamber 11 at a position close to the water outlet 12. The supporting portion 4 is a sealing ring arranged separately from the water outlet chamber 11, and an inner diameter of a position, contacting the water outlet panel 2, of the supporting portion 4 is smaller than the maximum diameter of the water outlet panel 2. When the water outlet panel 2 is coaxially arranged with the water outlet body 1 and completely covers the water outlet 12, the portion of the water outlet panel 2 with the maximum diameter is located on a side of the supporting portion 4 away from the water outlet 12.

In some embodiments, referring to FIG. 4, both a circumferential side wall of the water outlet panel 2 and an inner wall of the water outlet chamber 11 are complete spherical surfaces.

In some embodiments, referring to FIG. 4, in the axial direction of the water outlet panel 2, both sides of the water outlet panel 2 are provided with friction enhancement portions 5. Specifically, the friction enhancement portions 5 are annular convex lips, and circumferential thicknesses of the friction enhancement portions 5 on the two sides of the water outlet panel 2 can be the same or different. In some embodiments, the two friction enhancement portions 5 of the water outlet panel 2 have different thicknesses. A axial thickness of the friction enhancement portion 5 is in a range from 0.1 mm to 1 mm, and preferably, the axial thickness of the friction enhancement portion 5 is 0.3 mm, 0.4 mm, 0.5 mm, or 0.6 mm.

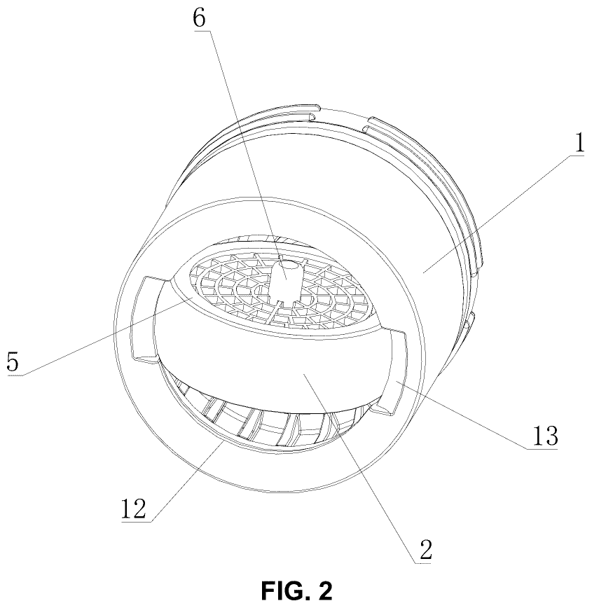

In some embodiments, referring to FIG. 2, to reduce the difficulty of reversing the water outlet panel 2, a rotation rod 6 is arranged in end surfaces of two axial sides of the water outlet panel 2 respectively, and an axial length of the rotation rod 6 is not greater than a maximum radius of the water outlet panel 2. When the water outlet panel 2 is squeezed by an external force or impacted by water flow, the water outlet panel 2 will contact the inner wall of the water outlet chamber 11, such that the water outlet panel 2 is always located in the water outlet chamber 11.

The working principle of some embodiments of the disclosure are as follows:

When the water outlet device is in operation, the water outlet panel 2 and the water outlet body 1 are basically in a coaxial state; and the axes of the water outlet panel 2 and the water outlet body 1 can also maintain a certain angle (for example, the included angle formed by the two axes is within 15 degrees), such that the water flow output by the water outlet panel 2 will deviate from a water inlet direction by a certain angle, which is consistent with the angle between the two axes.

Referring to FIGS. 2 and 5, when the water outlet panel 2 needs to be disassembled for cleaning, the water outlet panel 2 is reversed, such that the axis of the water outlet panel 2 is perpendicular to or nearly perpendicular to the axis of the water outlet 12, and the water outlet panel 2 is rotated along the circumferential direction of the water outlet, such that the water outlet panel 2 completely radially faces the two clearance openings 13, and the two water-passing end surfaces of the water outlet panel 2 are pinched by hand and pulled out towards the water outlet direction of the water outlet device. During this process, the supporting portion 4 will be slightly recessed due to the extrusion at the portion of the water outlet panel 2 with the maximum diameter.

The disassembled water outlet panel 2 can be cleaned of scale and other impurities by physical cleaning or chemical cleaning. Physical cleaning mainly involves scrubbing mesh holes of the water outlet panel 2 with cleaning tools to remove soft scale on the water outlet holes and other impurities blocking the mesh holes; and as to chemical cleaning, an acidic detergent can be used to soak the water outlet panel 2 to remove hard scale on the water outlet holes of the water outlet panel 2 or in the water channel inside the water outlet panel 2.

After cleaning, the axis of the water outlet panel 2 is positioned to be perpendicular to the axis of the water outlet 12, and the water outlet panel 2 completely radially faces the two clearance openings 13, then the water outlet panel 2 is pressed into the water outlet chamber 11 from the water outlet 12 and is fitted into the water outlet chamber 11 to complete assembly. Subsequently, either side of the water outlet panel 2 (selected according to the desired water sprays to be output) is reversed to cover the entire water outlet 12, after which the water outlet device is ready for normal operation.

In some embodiments, a water flow shaper is provided with only one clearance opening 13.

In some embodiments, to ensure that the water outlet panel 2 can be smoothly pulled out or fitted into the water outlet 12, a minimum distance from the clearance opening 13 to an axis center of the water outlet 12 is greater than a radius of the water outlet 12, and the difference is 0.05 mm, so as to avoid deformation of the water outlet 12 and reduce the difficulty of pulling out or embedding the water outlet panel 2. In other equivalent embodiments, the minimum distance from the clearance opening 13 to the axis center of the water outlet 12 can also be smaller than the radius of the water outlet 12, and the difference is smaller than 0.1 mm.

In some embodiments, referring to FIGS. 7 to 10, a water flow shaper is provided with a water outlet panel 2 with a different structure.

The water outlet panel 2 is provided with a first water-passing component 21 and a second water-passing component 22, and the first water-passing component 21 and the second water-passing component 22 have different water outlet structures/water outlet screens to form different water sprays. The circumferential side wall of the water outlet panel 2 is provided with a water inlet 23 that is in communication with both the first water-passing component 21 and the second water-passing component 22. When the water outlet panel 2 is coaxially arranged with the water outlet body 1, the water inlet 23 is located on the side of the supporting portion 4 away from the water outlet 12. When the water outlet panel 2 is coaxially arranged with the water outlet body 1, taking the first water-passing component 21 being the water inlet surface as an example, one part of the water flow first enters an interior of the water outlet panel 2 through the first water-passing component 21, and at the same time, another part flows into the interior of the water outlet panel 2 from the water inlet 23. The two parts of the water flow converge inside the water outlet panel 2 and then flow out through the second water-passing component 22. It can be understood that since the water outlet panel 2 is rotatably connected to the water outlet body 1, both the first water-passing component 21 and the second water-passing component 22 can be used as the water inlet surface. Regardless of which component is used as the water inlet surface, a part of the water flow will enter the water outlet panel 2 from the water inlet 23 as a flow supplement and converge with the other part of the water flow before flowing out from the water outlet surface.

In some embodiments, a water inlet channel 3 in communication with the water inlet 23 is formed between the water outlet panel 2 and the inner wall of the water outlet chamber 11, and different flow rates can be supplemented by designing the sizes of the water inlet 23 and the water inlet channel 3 accordingly.

The working principle of some embodiments of the disclosure are as follows:

Referring to FIG. 10, when the first water-passing component 21 is used as the water inlet surface, the water flow can enter the water outlet panel 2 after simultaneously passing through the first water-passing component 21 and then passing through the water inlet channel 3 and the water inlet 23 in sequence, and ultimately flow out through the second water-passing component 22 to output shaped water sprays.

On the contrary, the water outlet panel 2 can be reversed to position the second water-passing component 22 as the water inlet surface. When the first water-passing component 21 or the second water-passing component 22 is used as the water inlet surface, the water sprays flowing through the water outlet panel 2 have different forms.

In conclusion, according to the water flow shaper provided by the disclosure, in order that the water outlet panel can always remain in the water outlet chamber after water flow impact, the diameter of the water outlet is set to be smaller than the maximum diameter of the water outlet panel, such that the water outlet panel is always clamped in the water outlet chamber in a normal operation state. By providing a clearance opening on the water outlet, the water outlet panel can be pulled out from or fitted into the water outlet chamber after rotating to a position facing the clearance opening. This configuration not only ensures the stability of the water outlet panel in the water outlet chamber, but also realizes rapid assembly and disassembly of the water outlet panel. Consequently, the disassembly and assembly of the water outlet panel and the water outlet chamber are not limited by the material rigidity of the water outlet chamber or the water outlet panel, enabling broader applicability.

The above are only the embodiments of the disclosure, and are not intended to limit the patent scope of the disclosure. Any equivalent transformation made by using the contents of the description and drawings of the disclosure, whether directly or indirectly applied in the relevant technical fields, shall fall within the patent protection scope of the disclosure under the same principle.

What is claimed is:

1. A water flow shaper, comprising a water outlet body and a water outlet panel rotatably connected to the water outlet body, wherein
the water outlet body is provided with a water outlet chamber; the water outlet chamber is provided with a water outlet, and an inner diameter of the water outlet is smaller than a maximum diameter of the water outlet panel; and
the water outlet is provided with a clearance opening, such that the water outlet panel can be fitted into or detached from the water outlet through the clearance opening.

2. The water flow shaper according to claim 1, wherein in a circumferential direction of the water outlet, a length of the clearance opening is not less than an axial thickness of the water outlet panel.

3. The water flow shaper according to claim 1, wherein a difference between the length of the clearance opening and the axial thickness of the water outlet panel is in a range from 0.2 mm to 1 mm.

4. The water flow shaper according to claim 1, wherein at least two clearance openings are provided, with every two clearance openings being symmetrically arranged in a radial direction of the water outlet.

5. The water flow shaper according to claim 1, wherein the clearance opening is gradually recessed in the radial direction of the water outlet along a direction opposite to a water outlet direction.

6. The water flow shaper according to claim 1, wherein the water outlet chamber is provided with a neck at a position close to the clearance opening, and when the water outlet panel is fitted into or detached from the water outlet through the clearance opening, the water outlet panel is in transition fit with the neck.

7. The water flow shaper according to claim 6, wherein in an axial direction of the water outlet body, a thickness of the neck is in a range from 0.2 mm to 1.2 mm.

8. The water flow shaper according to claim 6, wherein a difference between a diameter of the neck and the maximum diameter of the water outlet panel is in a range from 0 mm to 0.5 mm.

9. The water flow shaper according to claim 1, wherein a ratio of the axial thickness of the water outlet panel to a diameter of the water outlet is in a range from 0.1 to 0.7.

10. The water flow shaper according to claim 1, wherein the water outlet chamber is provided with a supporting portion that presses against the water outlet panel.

11. The water flow shaper according to claim 10, wherein the water outlet panel is provided with a first water-passing component and a second water-passing component, a circumferential side wall of the water outlet panel is provided with a water inlet in communication with both the first water-passing component and the second water-passing component, and when the water outlet panel is coaxially arranged with the water outlet body, the water inlet is located on a side of the supporting portion away from the water outlet.

12. The water flow shaper according to claim 11, wherein a water inlet channel in communication with the water inlet is formed between the water outlet panel and an inner wall of the water outlet chamber.

13. The water flow shaper according to claim 10, wherein the supporting portion is integrally formed with the water outlet chamber, or the supporting portion is a sealing ring arranged separately from the water outlet chamber.

14. The water flow shaper according to claim 10, wherein an inner diameter of the supporting portion is smaller than the maximum diameter of the water outlet panel.

15. The water flow shaper according to claim 1, wherein the circumferential side wall of the water outlet panel and the inner wall of the water outlet chamber are configured as spherical surfaces or polygonal prismatic surfaces.

16. The water flow shaper according to claim 1, wherein in the axial direction of the water outlet panel, at least one side of the water outlet panel is provided with a friction enhancement portion.
